(19) United States
(12) Patent Application Publication
(10) Pub. No.: US 2021/0245677 A1
(43) Pub. Date: Aug. 12, 2021

(54) Camera Monitoring System, Method For Operating A Camera Monitoring System And Motor Vehicle

(71) Applicant: Continental Automotive GmbH, Hannover (DE)

(72) Inventor: Thomas SMITS, Frankfurt am Main (DE)

(21) Appl. No.: 17/172,951

(22) Filed: Feb. 10, 2021

(30) Foreign Application Priority Data
Feb. 12, 2020 (DE) 10 2020 201 766.2

(51) Int. Cl. B60R 11/04; H04N 7/18

(52) U.S. Cl. CPC B60R 11/04; H04N 7/185

(57) ABSTRACT

A camera monitoring system for a motor vehicle includes: a holder removably fastenable to an outside of the motor vehicle or to a front attachment of the motor vehicle, the holder having a first signaling coupler; a mobile camera removably fastenable to the holder and having a second signaling coupler, configured such that a transmission of information data between the camera and the holder is configurable by the second and first signaling couplers. The mobile camera is configured to capture image data of a surrounding area and to provide the captured image data wirelessly as measurement signals for further processing, and to receive information data of the holder and make the received information data available wirelessly for further processing. At least one controller receives and processes signals of the mobile camera and provides image signals for display for a monitor of the motor vehicle.

### BACKGROUND OF THE INVENTION

### 1. Field of the Invention

The present invention relates to a camera monitoring system for a motor vehicle, in particular for an agricultural vehicle. The invention also relates to a motor vehicle having such a camera monitoring system and to a method for operating a camera monitoring system for a motor vehicle.

### 2. Description of the Related Art

Vehicles can have a camera and a monitor that provide images of the surroundings for a user of the vehicle. For example, mirror replacement systems are known in which the fields of view of conventional exterior rear view mirrors are imaged by a camera and a monitor. Reversing cameras are also known with which it is possible to image areas cannot be seen with conventional mirrors. In addition, camera systems are also used in agricultural vehicles or utility vehicles such as excavators and tractors.

### SUMMARY OF THE INVENTION

An object of the invention is to provide a camera monitoring system and method for operating a camera monitoring system for a motor vehicle which each permit flexible use in a simple and cost-effective way.

According to one aspect of the invention, a camera monitoring system for a motor vehicle has a holder that can be fastened in a removable fashion on the outside of the motor vehicle or of a front attachment of the motor vehicle and that comprises a signalling coupler. The camera monitoring system also has a mobile camera that can be fastened in a removable fashion to the holder and which comprises a signalling coupler, so that transmission of information data between the camera and the holder can be configured by the signalling couplers. The camera is configured to capture image data of a surrounding area and provides the data wirelessly as measurement signals and further signals for further processing. The further signals can comprise, in particular, information data of the holder, which the camera has received. The camera monitoring system also has a controller configured to receive and process signals of the camera and provide image signals for display for a monitor of the motor vehicle.

By the described camera monitoring system it is possible to implement a flexible system that can be used with various attachments, can be easily and cost-effectively mounted on a motor vehicle and can contribute to beneficial operation. In the further description, the camera monitoring system is mainly described in conjunction with an agricultural vehicle as an embodiment of the motor vehicle, but its properties and features can also be transferred to use with other vehicles.

According to one preferred development of the camera monitoring system, the signalling couplers of the camera and of the holder are configured in such a way that a wireless transmission of information data can be configured between the camera and the holder. In particular, the signalling coupler of the holder can comprise an RFID transponder, and the signalling coupler of the camera can comprise an RFID reader, with the result that data can be read out from the holder by the camera in a wireless and contactless fashion.

Alternatively or additionally, the camera monitoring system can be embodied such that one of the signalling couplers of the camera and of the holder comprises a coupling plug, and the other of the signalling couplers of the camera and of the holder comprises a plug receptacle that is complementary to the coupling plug, with the result that a plug connection can be formed between the camera and the holder and can be used to configure an analog or digital transmission of information data between the camera and the holder.

According to one development of the camera monitoring system, the mobile camera has a lens with an angle of aperture of 220°. In this way, the camera monitoring system can be reliably operated with just one camera. Alternatively, the camera can also have a lens with a larger or smaller angle of aperture of e.g., 240°, 200° or 180°. Alternatively or additionally, further cameras can also be used to capture further surrounding areas or to contribute to a particularly safe and reliable camera monitoring system if, for example, a camera fails, or, for example, to adjust the captured image areas of different cameras to one another.

According to one development of the camera monitoring system, the mobile camera has a magnet that forms a magnetic retaining force in conjunction with the holder. The magnet is embodied, for example, as a neodymium magnet. The holder is fabricated, for example, from metal or comprises metal, in particular a ferromagnetic metal, with the result that a reliable magnetic retaining force can be formed in conjunction with the magnet of the camera. Alternatively, the holder can also be fabricated from plastic and have a metal ring or the like, with the result that the camera can be fastened magnetically.

Furthermore, the camera monitoring system can be embodied in such a way that the holder can be fastened to the agricultural vehicle or to a front attachment of the agricultural vehicle by a magnet. Alternatively or additionally, the holder can be mounted on the agricultural vehicle or on the front attachment by fasteners such as, for example, screws. The holder can, in particular, be fastened such that it can be non-destructively fastened to the agricultural vehicle and removed again. The holder can be fastened to an outer side of the agricultural vehicle facing away from an interior space of the agricultural vehicle. The holder can be fastened to the outside of the agricultural vehicle, with the result that during operation the holder is in contact with the environment. The holder can therefore be easily coupled to different agricultural vehicles and provides a receptacle for the camera.

The holder can also be coupled to different camera or cameras and forms, for example, a shell-shaped receptacle which is embodied in a way adapted to the camera. By the camera and the holder, a modular system is formed, which can be employed flexibly depending on the desired use. It is possible to fasten the holder only temporarily to the agricultural vehicle if a use is desired.

The holder is configured to receive and hold the camera. For example, the camera is embodied in a cylindrical shape, with the result that the holder provides an annular receptacle. Alternatively, the camera can also be embodied as a cuboid and can be intended for use in a square holder. The camera can therefore be fastened to the agricultural vehicle by the holder. For example, the camera can be fastened to the holder by magnets. The camera can be non-destructively removed again from the holder. It is therefore possible, for example, to use the camera for a multiplicity of agricultural vehicles and/or front attachments for agricultural vehicles, which each have a separate holder. In addition, it is possible to mount the holder on various agricultural vehicles. For example, it is possible to mount the holder on the agricultural vehicle only during the time that the agricultural vehicle is operating, and otherwise to remove it from the agricultural vehicle, for example when the agricultural vehicle is parked.

The camera is, for example, configured as described in DE 10 2017 208 592 or DE 10 2018 218 735.

Moreover, the holder and/or the camera can be embodied in such a way that electrical energy for operating the camera can be transmitted wirelessly from the holder to the camera. For example, the holder and/or the camera have/has a chargeable accumulator. For example, the holder and/or the camera have/has an energy transmitter and/or an energy receiver which can be coupled electrically to an accumulator, e.g., a battery. Electrical energy can be transmitted wirelessly from the energy transmitter to the energy receiver, for example on the basis of induction by coils. Therefore, according to exemplary embodiments it is possible to supply the camera during operation with electrical energy in the fastened state in the holder. For this purpose, in particular there is no need for cabling to be provided between the holder and the camera. However, it is also alternatively or additionally possible to provide a cable connection or plug connection for supplying energy to the described components.

According to a further aspect of the invention, an agricultural vehicle comprises a front attachment arranged on a front side of the agricultural vehicle and coupled thereto, and an embodiment of the camera monitoring system described above, which is coupled to the front attachment by the holder. The motor vehicle is implemented, in particular, as an agricultural vehicle, for example as a tractor, which has a functional front attachment that can be coupled to the tractor when required. The camera monitoring system can therefore also be referred to as front-mounted camera monitoring system.

Alternatively or additionally, the described camera monitoring system can, however, also be used in other utility vehicles such as an excavator or a crane, with the result that a contribution can be made to safe and convenient operation of the respective vehicle. As a result of the fact that an agricultural vehicle has an embodiment of the camera monitoring system described above, the described properties and features of the camera monitoring system are also disclosed for the utility vehicle, and vice versa.

According to a further aspect of the invention, a method for operating a camera monitoring system for an agricultural vehicle comprises coupling a camera to a holder of the camera monitoring system by respective signalling couplers of the camera and of the holder. The coupling can also comprise mechanically coupling the camera to the holder by inserting the camera into the holder or mounting it thereon. The method also comprises coupling the camera and the holder to the agricultural vehicle or to a front attachment of the agricultural vehicle. The coupling comprises here, in particular, signalling coupling to a part of the agricultural vehicle or of the front attachment is enabled for this. In addition, the coupling can also comprise mechanical coupling of the camera and of the holder in that the latter are mounted on the agricultural vehicle or on the front attachment.

The method also comprises wirelessly transmitting between the camera, the holder, the agricultural vehicle and/or the front attachment, the information data of the components which couple to one another, wherein at least one of the coupling components comprising the camera, holder, agricultural vehicle or front attachment has a controller. The control unit enables one of the components to receive, process and provide data or signals. The respective component can also be referred to as an electronically intelligent component. The camera and the agricultural vehicle are preferably also embodied as electronically intelligent components and each have a controller enabled for signal-transmitting communication.

The method also comprises receiving and processing transmitted data of the camera, of the holder, of the agricultural vehicle and/or of the front attachment by the controller, and as a result detecting the components that are coupled to one another in a signal-transmitting fashion, and configuring the camera monitoring system as a function of the detected components.

In this way, a camera monitoring system can be configured automatically by the described method and can contribute to convenient and beneficial operation of the agricultural vehicle. By the described method, the components of the camera monitoring system can be detected in an automated fashion, and there is no need to make a manual input in order to configure the camera monitoring system. As a result of the fact that the method makes it possible in particular to operate a refinement of the camera monitoring system described above, the described properties and features of the camera monitoring system are also disclosed for the method, and vice versa.

According to one development of the invention, the processing of the transmitted data and the configuring of the camera monitoring system comprise providing an displaying image signals by a monitor of the agricultural vehicle as a function of the detected components are coupled to one another in a signal-transmitting fashion. The provision and displaying of image signals by the monitor of the agricultural vehicle are carried out in particular as a function of a specified time threshold value, which is less than or equal to 200 ms. In this way, automated auto-configuration of the camera monitoring system can take into account required end-to-end processing latency, with the result that a contribution can be made to carrying out reliable configuration and display under close to real-time conditions.

According to one embodiment, the method comprises receiving measurement signals of the camera that comprise image data of the surroundings of the camera, processing the received measurement signals and providing image signals by the controller. Furthermore, the method comprises displaying the provided image signals by the monitor. In this way, the captured surroundings in the region of the camera and also information about the interacting components can be displayed to a driver of the agricultural vehicle. For example, the detected components and devices can be displayed on the monitor to the driver of the agricultural vehicle. Changes or confirmations can be optionally made or requested by the driver.

According to a further development of the method, the processing of the received measurement signals of the camera comprises evaluating and delimiting an image area which has been captured by the camera, and/or evaluating and setting an orientation of the camera by receiving a measurement signal of an acceleration sensor of the camera. In this way, a contribution can be made to particularly reliable and efficient operation of the camera monitoring system and of the agricultural vehicle equipped therewith.

A realization relating to the present invention is that, for example, tractors can generally be used with changing attachments which can be hitched both to the rear and to the front of the tractor. If such an attachment is implemented as a tractor front attachment, and such a tractor-trailer combination exceeds a front-part dimension of 3.5 m (measured from the steering wheel of the tractor up to the frontmost part of the front attachment), traffic regulations require an accompanying person to be provided as someone to give directions.

Alternatively, according to a supplementary Transport Journal (Amtsblatt des Bundesministeriums für Verkehr and digitate Infrastruktur der Bundesrepublik Deutschland [Official Journal of the Federal Ministry for Traffic and Digital Infrastructure of the Federal Republic of Germany), systems for displaying indirect fields of vision that have to satisfy the requirements contained therein can be used. Such systems are referred to as front-mounted camera monitoring systems (VKMS) and can, for example, be inspected and certified by the Deutschen Landwirtschafts-Gesellschaft DLG [German Agricultural Society]. For example, such inspection is limited to the respective front-mounted attachment in combination with the associated tractor, with the result that a respective attachment is approved only in conjunction with a specific tractor, and corresponding equipment with a VKMS is approved only for this specific combination. In order to satisfy the requirements in the Traffic Journal (in particular relating to the resolution of the cameras used) there are mainly conventional systems which:
are fixedly installed on the attachment,
or have to be mechanically secured/screwed to relatively heavy robust metal housings,
have analog, wire-bound cameras,
always have to be inspected/certified and marketed only as a “whole system” composed of precisely defined cameras, splitters (combinations for displaying two fields of vision on a display) and monitors.

Since an admissible VKMS end-to-end is certified, such a conventional system can only be sold and operated as a “whole”. Moreover, such a conventional system requires the use of a separate monitor from the system supplier. Accordingly, an additional monitor is required in a tractor equipped with such a conventional system.

A further realization relating to the present invention is that, in order to satisfy the resolution requirements in conventional systems, two cameras with a relatively small angle of aperture of 40°-60° are always used. In this context, one camera is oriented to the left in the direction of travel, and the other to the right. As a result, such a conventional VKMS can be used only for the purpose of turning or driving into a section of road.

Furthermore, until now VKMSs have usually been permanently cabled and have to be respectively cabled or plugged in by the user when the attachment is hitched. The cabling installation itself is costly because in addition to the simple lines for supplying power it is also necessary to lay analog video lines. Moreover, it is necessary to cable the attachment and the tractor from the receptacle of a front hydraulic system as far as the interior of a cab of the tractor.

By the described camera monitoring system and the corresponding method for operating the camera monitoring system according to the present invention it is possible to make, in an easy and cost-effective fashion, a contribution to an automated and time-saving configuration of the interactive components and to efficient operation of the tractor or of an agricultural vehicle.

The described camera monitoring system and the corresponding method respectively permit use with various attachments and with components from different manufacturers. A reliable functionality can be implemented for various tractors and vehicles. A transmission of images from the camera to the monitor of the agricultural vehicle is carried out, in particular, wirelessly, with the result that cabling expenditure when mounting the camera is reduced.

Furthermore, the described camera monitoring system can be operated with just one camera, so that the costs of the camera monitoring system can be reduced. However, alternatively it is also possible to use two or more cameras.

The camera of the camera monitoring system is preferably embodied such that it can be plugged in without using tools and with little expenditure for the user, and can be coupled to the holder. Despite the flexibility, the mobile camera can also be moved from one attachment to the next in a way that is protected against incorrect operation. The camera can also be used not only for a specific purpose of use under certain circumstances but also, in particular, can assist relatively normal working processes owing to its mobility.

Furthermore, by virtue of the modular design of the camera monitoring system as described, there is no need for a separate or additional monitor, but instead the camera monitoring system can be combined, in particular automatically, with defined monitors already present. This can be done, for example, by transmitting data from the components between them and/or with the controller within the scope of the described method and can contribute to automated and convenient device detection.

Moreover, the described camera monitoring system can be enabled to configure a suitable visual representation on the monitor with different working positions of the attachment or of the agricultural vehicle. For example, in this way it is possible to display a continuously horizontally aligned camera image of the camera on the monitor despite an inclination.

The camera of the described camera monitoring system is embodied, in particular, as a mobile and wireless or cableless camera with an installed energy accumulator and a wireless interface, and is embodied in a way adapted to use in the holder (which holder can also be referred to as a “cradle”).

In particular, the holder is embodied with an RFID tag and can provide information data for the wireless reading out for the camera enabled for this.

In this way, for example the associated agricultural vehicle and/or the mounted front attachment on which the holder is installed can be detected. In addition, a field of vision of the camera can be configured automatically and appropriately for the agricultural vehicle or its front attachment for various machines and for components from different manufacturers. Optionally, the holder can also have a controller and be embodied as an electronically intelligent component.

The camera and the holder are, in particular, embodied such that they are adapted to one another such that simple and precisely dimensioned positioning and centering of the camera can be configured. Time-saving mounting without tools and secure and reliable positioning of the camera in or on the holder are preferably implemented such that relatively strong neodymium magnets in or on the camera interact with a ferromagnetic metal ring in or on the holder. Alternatively or additionally, it is possible to provide one or more latching hooks or other kinds of couplers which permit mechanical locking of the camera relative to the holder, so that the camera can be placed in a correctly rotated position.

Use of just one camera is made possible by virtue of the fact that the camera has an image sensor with a correspondingly high resolution and comprises a lens which preferably has a relatively large angle of aperture of, for example, 220°. The camera monitoring system and the method are then preferably configured to electronically eliminate outer image areas which are possibly not relevant for the driver and the operation of the agricultural vehicle or front attachment.

In this context it may be advantageous to provide for the camera to be secured in a gripping or holding fashion in such a way that the camera is positioned such that the image sensor installed in the camera, and which has, for example, an aspect ratio of 4:3 or 16:9, is aligned on its longer side with a horizontal of the surroundings. In this way, the resolution of the image sensor can be used in the best possible way for the customary operation of the agricultural vehicle. Alternatively or additionally, the camera can have one or more acceleration sensors, so that automatic orientation of the image format occurs even if the camera has a rounded shape or cylindrical shape and does not have an immediately detectable preferred position.

The camera forms a signalling reception side which can be connected by the holder to a BUS system of the front attachment and/or of the agricultural vehicle, so that a hydraulic position, a steering angle and/or a speed of the agricultural vehicle can also be taken into account in the camera monitoring system. Within the scope of the method for operating the camera monitoring system, it is possible also to include such additional information data and to use it, for example, to automatically adapt the camera or the surroundings captured thereby. Alternatively, the receiver provided by the camera can also permit merely identification or detection of the components which are networked in a signal-transmitting fashion, without being connected to the BUS system of the front attachment and/or of the agricultural vehicle.

As a result of the fact that all the components coupled to one another in terms of signalling can be detected in an automated fashion by the camera monitoring system, all the parameters can also be included in the image-processing evaluation, and the camera monitoring system and the provision of image data for display on the monitor can be configured appropriately. For example, the image quality or scaling can be set appropriately such that a resolution, a display size or other image parameters always bring about correct representation on the monitor despite components from different manufacturers. During such information processing, in particular the position of the attachment and the defined position of the holder and information data of the tractor, such as physical/mechanical properties and installed components, such as for example the display or the monitor or further components, can also be taken into account and also included in the method for operating the camera monitoring system.

Further parameters, such as for example a gamma curve of the monitor, can also be taken into account. In this way, acquired surroundings data and associated image signals can be displayed with greater dynamics, and the individual components can be advantageously used.

In particular, a timing behavior of individual processing blocks can be known and taken into account, such as for example a processing latency for decoding a video stream of the camera that is used. The camera monitoring system and the method for operating the camera monitoring system are, in particular, embodied with respect to such a timing behavior such that the purely physical parameters of the monitor, such as, for example, its inertia as a function of temperature, are also taken into account in order to permit ordered end-to-end latency, which does not exceed 200 ms. In this context, temperature measurement can also occur, which is carried out, for example, on the basis of a temperature sensor which is coupled to the vehicle bus. Alternatively or additionally, a temperature measurement can be carried out by the monitor and a measured temperature can be provided and taken into account. Furthermore, the fact that all the components that are coupled in a signal-transmitting fashion in the camera monitoring system are detected in an automated fashion, and are therefore known, permits a contribution to be made to the functional safety of the operation of the agricultural vehicle with a front attachment.

### BRIEF DESCRIPTION OF THE DRAWINGS

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

Exemplary embodiments of the invention will be explained below with reference to schematic drawings. In which drawings:

FIG. 1 shows a schematic illustration of an exemplary embodiment of an agricultural vehicle with a camera monitoring system;

FIG. 2 shows a schematic example embodiment of a camera and a holder of the camera monitoring system in two views;

FIG. 3 shows a block diagram of a method for operating the camera monitoring system; and

FIG. 4 shows a flow diagram of the method for operating the camera monitoring system.

### DETAILED DESCRIPTION OF THE PRESENTLY PREFERRED EMBODIMENTS

Elements having the same design and function are denoted by the same reference signs throughout the figures. For the sake of clarity, it may be the case that not all elements are denoted by associated reference signs in all of the figures.

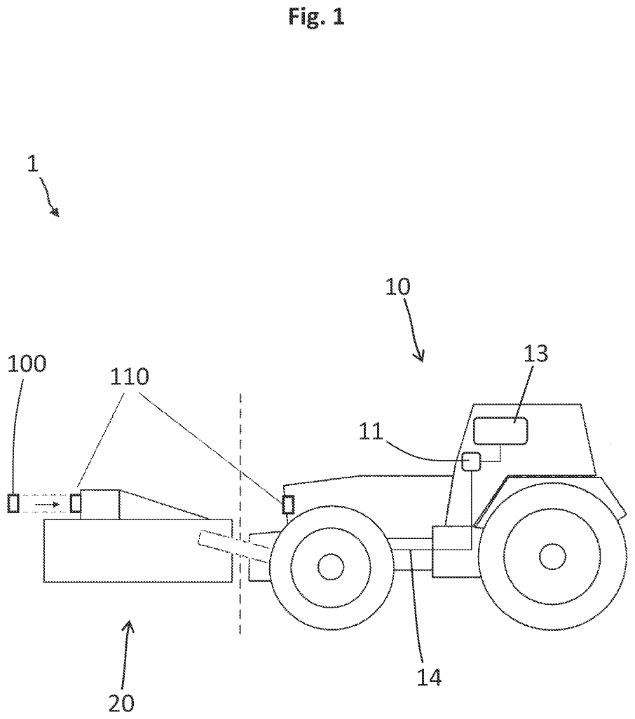

FIG. 1 shows a schematic illustration of an agricultural vehicle in the form of a tractor 10 coupled at a front side to a functional front attachment 20. The tractor 10 and the front attachment 20 are also coupled to a camera monitoring system 1. As is explained below with reference to FIGS. 1 to 4, the camera monitoring system 1 can be used in a flexible way with a variety of attachments and can easily and cost-effectively contribute to beneficial and advantageous operation of the tractor 10.

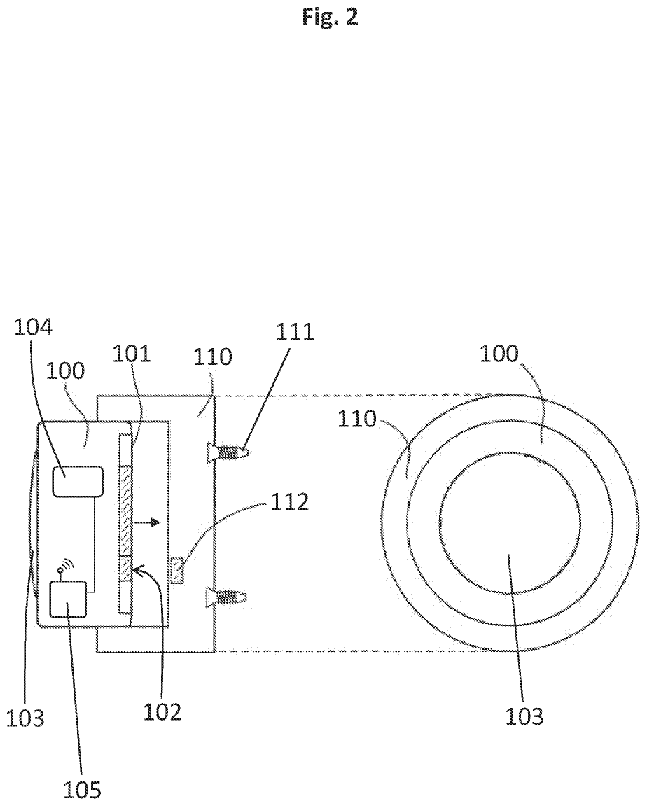

The camera monitoring system 1 has a holder 110 fastened in a removable fashion to the outside of the front attachment 20 of the tractor 10. Alternatively or additionally, a holder 110 is fastened to the outside of the tractor 10, which can also be beneficial if the tractor 10 is operated, for example, without a front attachment 20. The holder 110 can be fastened by a screw connection 111 (see FIG. 2). Alternatively or additionally, the holder 110 can have a magnet, so that the holder 110 can be fastened to the tractor 10 and/or the front attachment 20 by a magnetic retaining force.

The camera monitoring system 1 also has a mobile camera 100 which can be fastened in a removable fashion in or on the holder 110. The camera 100 has a lens 103 with a preferably relatively large angle of aperture of, for example, 220°, and is configured to acquire image data on the surroundings and to provide this data in a wireless or cableless fashion as measurement signals for further processing, in particular for visual display on a monitor 13 of the tractor 10. The camera 100 therefore has a communicator 105 coupled in a signal-transmitting fashion to a controller 104 and which permits wireless transmission of measurement signals and/or image data to reception-enabled components.

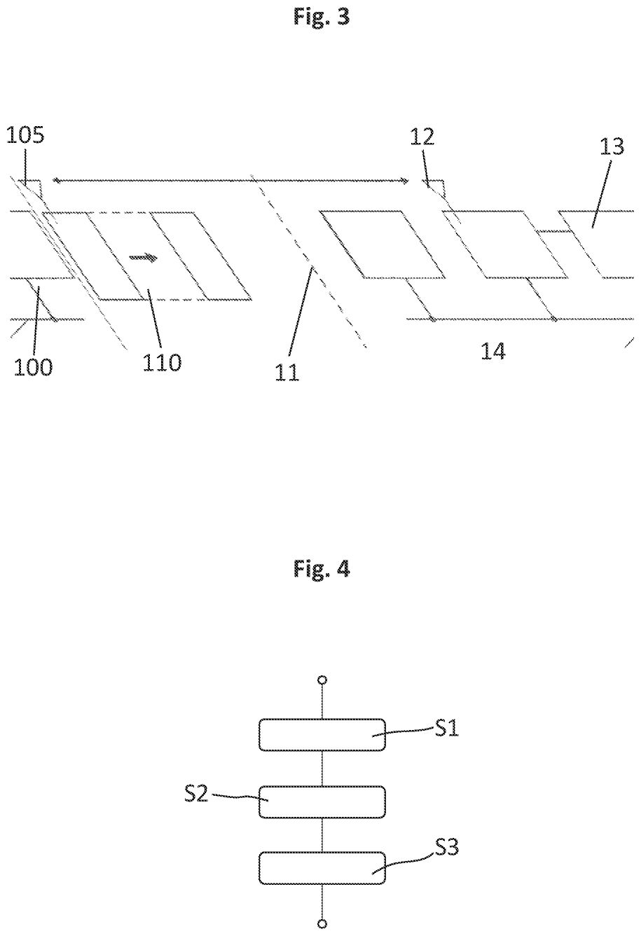

In the present exemplary embodiment, the tractor 10 also has a controller 11 and a communicator12 (see FIG. 3) so that image data and information data from the camera 100 can be sent wirelessly to the communicator 12 of the tractor 10 by the communicator 105 and displayed by the monitor 13. Alternatively or additionally, signals can be transmitted by a vehicle bus 14 of the tractor 10, which, after corresponding coupling, can also extend into the front attachment 20 and to the respective holder 110. The vehicle bus 14 can be optionally configured as a signal line, such that it extends as far as the holder 110 on the tractor 10 and/or as far as the holder 110 on the front attachment 20.

FIG. 2 is a schematic illustration of the camera 100 and of the holder 110 in various views. The left-hand part of the image shows the camera 100 and the holder 110 in a side view, a plan view or a view from below. The right-hand part of the image shows the camera 100 and the holder 110 in a view from the front in the direction of the tractor 10.

The holder 110 and the mobile camera 100 each have a signal-transmitting coupler 112 and 102, respectively, so that a wireless transmission of information data can be configured between the camera 100 and the holder 110. Such a transmission of data can serve, in particular, to interrogate information data of the interacting components coupled to one another in a signal-transmitting fashion. The transmission of data is preferably carried out by RFID technology, so that, for example, the coupler 112 of the holder 110 has an RFID label and the coupler 102 of the camera 100 comprises an RFID reader configured to read out electronically the information data of the holder 110 stored in the RFID label.

The camera 100 is thus also configured to receive and/or process information data of the holder 110 and/or provide this data for further processing or send it wirelessly by the communicator105. In this context, data or signals can be processed entirely or partially in the controller 104 of the camera 100 or entirely or partially in the controller 11 of the tractor 10. The controllers 11 and 104 are each configured to receive and process signals of the camera 100 and/or provide image signals for display for the monitor 13 of the tractor 10. In this context, the signals can comprise measurement signals and information data such as identification numbers or device designations.

For example, information data that comprises information about the model, the functionality and the dimensions of the front attachment 20 are stored on the RFID label of the holder 110 of the front attachment 20. The information stored in the RFID label can be read out by the mobile camera 100, which is easy to plug into the holder 110, and that information is transmitted to the controller 11 of the tractor 10 and, if appropriate, displayed on the monitor 13 to bring it to the awareness of a driver of the tractor 10.

The holder 110 and the mobile camera 100 are embodied, in particular, in a way adapted to one another. This preferably relates also to the shape of the two components. According to the exemplary embodiment illustrated in FIG. 2, the camera 100 is embodied in a cylindrical shape, and the holder 110 constitutes a corresponding annular shell receptacle into which the camera 100 can be plugged (indicated by the arrow in the left-hand part of the image in FIG. 2).

So that reliable holding and/or predefined orientation of the camera 100 in the holder 110 can be configured, the camera 100 has one or more retaining magnets 101 which are configured, for example, as neodymium magnets and which interact with the holder 110. The holder 110 is fabricated, for example, from metal or comprises metal, so that it is possible to configure a reliable magnetic retaining force which fastens the camera 100 in the holder 110. For example, the holder 110 is fabricated from a plastic and has a metal ring to which the camera 100 can be magnetically locked. The holder 110 can also be fastened by appropriate mounting adapters for a respective machine or another front attachment 20.

FIG. 3 is a block diagram that illustrates interaction between the components of the camera monitoring system 1 and of the tractor 10, which are coupled in a signal-transmitting fashion. The controller 11 of the tractor 10 is illustrated, by way of example. The controller 11 and the receiver or communicator12 could also be integrated into the monitor 13. The bus connection to the vehicle bus 14 is optional. Alternatively or additionally, it is possible, as indicated, for a direct connection to be configured between the communicator12 and the monitor 13 of the tractor 10, which connection permits, for example, a video stream or video transmission if the vehicle bus 14 is not configured for such a type of data transmission, for example, or the video transmission is already output in a decoded form. Such video transmission can be output in various ways by the communicator12 and/or the controller 11:

a) Decoded: i. analog, ii. digital;
b) Not decoded as a video data stream;
c) Transcoded as a changed video data stream

A bidirectional communication capability of the communicators105 and 12 of the camera 100 and of the tractor 10 is indicated by an arrow in FIG. 3. Alternatively, the communicator105 is configured only for transmitting and the communicator12 of the tractor 10 only for receiving data and/or signals. The holder 110 is preferably mounted at the front of the front attachment 20. A further beneficial position according to FIG. 1 is on the front of the tractor 10. Accordingly, the camera 100 could also be fastened to the tractor 10 and nevertheless contribute to reliable and convenient operation of the tractor 10.

In a further embodiment, the camera can actuate an actuator of the holder 110 wirelessly using short-range radio technology, in order, for example, to actuate a pump for a cleaning system with a nozzle for cleaning the camera lens 103 of the camera 100. Likewise, a heater can be provided for de-icing the camera lens 103 in the camera 100 and/or the holder 110. Therefore, costs and the complexity of the camera 100 can be kept low.

Furthermore, a multi-axis acceleration sensor can be used within the camera 100. Therefore, the image captured by the camera 100 can always be correctly oriented toward a road, even if the tractor 10 is in an inclined position because it is, for example, moving out from a dirt road. Information from or provided by the vehicle bus 14 can optionally be additionally combined with values of the acceleration sensor, so that, for example, a position of front-mounted hydraulic arms of the front attachment 20 can be taken into account. In addition to information data which can be interrogated and processed by the vehicle bus 14, it is additionally possible, for example, to capture and take into account the measurement signals of a further acceleration sensor which provides information about an inclination of the tractor 10.

A method for operating the camera monitoring system 1 can be carried out according to the flow diagram illustrated in FIG. 4. In a step S1, the camera 100 is coupled to the holder 110 of the camera monitoring system 1 by the signalling couplers 102 and 112. This relates, in particular, to signal-transmitting coupling and can also comprise mechanical coupling of the camera 100 to the holder 110 by inserting or plugging the camera 100 into the receptacle shell of the holder 110 until the retaining magnets 101 form a magnetic lock with the holder 110.

In a step S2, the camera 100 and the holder 110 couple to the front attachment 20 or to the tractor 10 by, for example, configuring a communication facility between the communicator105 of the camera 100 and the communicator 12 of the tractor 10. Alternatively or additionally, a communication facility for transmitting data or signals between the camera 100 and the tractor 10 can be configured by the vehicle bus 14.

In a further step S3, data is transmitted between the camera 100, the holder 110, the tractor 10 and/or the front attachment 20, which data comprises information data of the components 100, 110, 10, 20 which couple to one another. Such data transmission preferably takes place wirelessly in that, for example, information data of the holder 110 is interrogated wirelessly by the camera 100 on the basis of the RFID functionality of the couplers 102 and 112, and also transferred wirelessly to the communication unit 12 of the tractor 10 by the communicator 105. Alternatively or additionally, the acquired image data of the camera 100 can be transferred wirelessly or by the vehicle bus 14 to the controller 11 or to the communicator12 of the tractor 10, which is connected to the controller 11 and provides the image data for further processing.

As a result of the fact that at least one of the coupling components composed of the camera 100, holder 110, tractor 10 or front attachment 20 has a controller, the transmitted data and/or signals can be received and processed by the controller 104 and/or 11, so that the components 100, 110, 10, 20, which are coupled to one another in a signal-transmitting fashion, including sub-components such as the monitor 13, are detected, and the camera monitoring system 1 can be advantageously configured as a function of the detected components 100, 110, 10, 20.

The camera 100 can also be used to carry out plausibility checking of the geometry of the front attachment 20. For example, information indicating that the front attachment 20 is a shovel or a sweeping attachment can be stored in the RFID label of the coupler 112 of the holder 110, so that the camera 100 can also be used to check visually whether corresponding dimensions or shapes are present. Alternatively or additionally, for example markers or identifiers present on the front attachment 20 can be checked visually by the camera 100, and the plausibility of the information data of the holder 110 can therefore be checked.

Furthermore, the camera 100 permits a position of the front attachment 20 to be checked or assessed, so that, for example, a driving position or a working position of the front attachment 20 is detected and, if appropriate, a message to the driver of the tractor 10 is provided and output on the monitor 13.

The described camera monitoring system 1 does not require any plug-type connectors and can, for example, be configured such that it can be charged or operated without cables. In particular, the camera monitoring system 1 permits wireless or cableless transmission of video data streams. The described camera monitoring system 1 can therefore always permit correct end-to-end display of image data relating to the electronic processing and displaying of signals, despite changing components, such as different front attachments. An additional monitor can be dispensed with and the camera 100 can be re-used on other agricultural vehicles or front attachments. The camera monitoring system 1 can therefore be used flexibly independently of the front attachment 20 and the tractor 10. Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. A camera monitoring system (1) for a motor vehicle (10), comprising:
a holder (110) removably fastenable to an outside of the motor vehicle (10) or to a front attachment (20) of the motor vehicle (10), the holder (110) having a first signaling coupler (112);
a mobile camera (100) removably fastenable to the holder (110) and having a second signaling coupler (102), configured such that a transmission of information data between the camera (100) and the holder (110) is configurable by the second and first signaling couplers (102, 112), wherein the mobile camera (100) is configured to capture image data of a surrounding area and to provide the captured image data wirelessly as measurement signals for further processing, and to receive information data of the holder (110) and make the received information data available wirelessly for further processing; and
at least one controller (11, 104) configured to receive and process signals of the mobile camera (100) and provide image signals for display for a monitor (13) of the motor vehicle (10).

2. The camera monitoring system (1) as claimed in claim 1, wherein the second and first signaling couplers (102, 112) of the mobile camera (100) and of the holder (110) are configured such that wireless transmission of information data is configurable between the mobile camera (100) and the holder (110).

3. The camera monitoring system (1) as claimed in claim 2, wherein the first signaling coupler (112) of the holder (110) comprises an RFID transponder, and the second signaling coupler (102) of the mobile camera (100) comprises an RFID reader.

4. The camera monitoring system (1) as claimed in claim 1, wherein the mobile camera (100) has a lens (103) with an angle of aperture of 220°.

5. The camera monitoring system (1) as claimed in claim 1, wherein the mobile camera (100) has a magnet (101) that forms a magnetic retaining force in conjunction with the holder (110).

6. The camera monitoring system (1) as claimed in claim 1, wherein the holder (110) has a metal element that forms a magnetic retaining force in conjunction with the magnet (101) of the mobile camera (100).

7. The camera monitoring system (1) as claimed in claim 1, wherein the holder (110) and/or the mobile camera (100) comprises an energy accumulator, and electrical energy for operating the mobile camera (100) is transmittable from the holder (110) to the mobile camera (100).

8. A motor vehicle (10) comprising:
the front attachment (20) arranged on a front side of the motor vehicle (10) and coupled thereto, and
the camera monitoring system (1) as claimed in claim 1, which camera monitoring system (1) being coupled to the front attachment (20) by the holder (110).

9. A method for operating a camera monitoring system (1) for a motor vehicle (10), comprising:
coupling a camera (100) to a holder (110) of the camera monitoring system (1) by respective signaling couplers (102, 112) of the camera (100) and of the holder (110);
coupling the camera (100) and the holder (110) to the motor vehicle (10) or to a front attachment (20) of the motor vehicle (10);
wirelessly transmitting data between the camera (100), the holder (110), the motor vehicle (10) and/or the front attachment (20), which data comprises information data of the components (100, 110, 10, 20) that are coupled to one another, wherein at least one of the coupled components composed of the camera (100), holder (110), motor vehicle (10) or front attachment (20) has a controller (104, 11); and
receiving and processing the transmitted data of the camera (100), of the holder (110), of the motor vehicle (10) and/or of the front attachment (20) by the controller (104, 11), and as a result of the processing detecting the components (100, 110, 10, 20) which are coupled to one another in a signal-transmitting fashion, and setting up the camera monitoring system (1) as a function of the detected components (100, 110, 10, 20).

10. The method as claimed in claim 9, wherein the processing of the transmitted data and the setting up of the camera monitoring system (1) comprises:
providing and displaying image signals by a monitor (13) of the motor vehicle (10) as a function of the detected components (100, 110, 10, 20) which are coupled to one another in a signal-transmitting fashion.

11. The method as claimed in claim 10, wherein the provision and displaying of image signals by the monitor (13) of the motor vehicle (10) are carried out as a function of a specified time threshold value which is less than or equal to 200 ms.

12. The method as claimed in claim 10, further comprising:
receiving measurement signals of the camera (100) which comprise image data on surroundings of the camera (100);
processing the received measurement signals and providing image signals by the controller (104, 11); and
displaying the provided image signals by the monitor (13).

13. The method as claimed in claim 12, wherein the processing of the received measurement signals of the camera (100) comprises:
evaluating and delimiting an image area which has been captured by the camera (100), and/or
evaluating and setting an orientation of the camera (100) by receiving a measurement signal of an acceleration sensor of the camera (100).
